(19) United States
(12) Patent Application Publication
(10) Pub. No.: US 2007/0273850 A1
(43) Pub. Date: Nov. 29, 2007

(54) Extreme Ultra Violet Lithography Apparatus

(76) Inventor: Barrie Dudley Brewster, Brighton (GB)

Correspondence Address: THE BOC GROUP, INC., 575 MOUNTAIN AVENUE, MURRAY HILL, NJ, 07974-2064, US

(21) Appl. No.: 10/576,505

(22) PCT Filed: Sep. 20, 2004
(86) PCT No.: PCT/GB04/04020

§ 371 Date: May 17, 2007

(30) Foreign Application Priority Data
Oct. 24, 2003 (GB) 0324883.8

(51) Int. Cl. G03B 27/42

(52) U.S. Cl. 355/30

(57) ABSTRACT

Lithography apparatus comprises a lithography tool housed in a first chamber, and a source of radiation at or below ultra violet wavelengths housed in a second chamber connected to the first chamber to enable radiation generated by the source to be supplied to the tool. A cryogenic vacuum pump is provided for at least one, preferably for each, of the chambers. A target material, such as xenon, supplied to the source for the generation of radiation is pumped from the second chamber, cryogenically purified and re-supplied to the source. A cryogenic refrigerator supplies cryogen to the cryogenic purifier and to the cryogenic vacuum pump(s).

The invention relates to extreme ultra violet lithography (EUVL) apparatus.

In lithographic processes used in the manufacture of semiconductor devices, it is advantageous to use radiation of very short wavelength, in order to improve optical resolution, so that very small features in the device may be accurately reproduced. In the prior art, monochromatic visible light of various wavelengths have been used, and more recently radiation in the deep ultra violet (DUV) range has been used, including radiation at 248 nm, 193 nm and 157 nm. In order to further improve optical resolution, it has also been proposed to use radiation in the extreme ultra violet (EUV) range, including radiation at 13.5 nm.

The use of EUV radiation for lithography creates many new difficulties, both for the optics in the lithography tool, and also in the EUV radiation source.

The lens materials used for projection and focussing of radiation in DUV lithography, such as calcium fluoride, are not suitable for transmission of EUV radiation, and it is usually necessary to use reflective optical devices (mirrors) in place of transmissive optical devices (lenses). These mirrors generally have multilayer molybdenum-silicon surfaces, which are extremely sensitive to contamination. In the presence of EUV radiation, secondary electrons are released from the mirror surface, which interact with contaminants on the surface, reducing their reflectivity. Adsorbed water vapour on the mirror surface causes oxidation of the uppermost silicon layer. Adsorbed hydrocarbon contaminants are cracked to form graphitic carbon layers adhering to the surface. The resulting loss of reflectivity leads to reduced illumination and consequent loss of tool productivity. Due to the high cost of these optical components, it is always undesirable to replace them, and in many cases it is completely impractical. A further problem is that EUV radiation has poor transmissibility through most gases at atmospheric pressures, and therefore much of the mechanical, electrical and optical equipment involved in the lithography process must be operated in a high-purity vacuum environment. In many cases, gas purge flows are used to prevent contaminating materials (such as photoresist and photoresist by-products) reaching the optical components, and to provide cooling and to prevent migration of particles. Gases may also be used in hydrostatic or hydrodynamic bearings in order to allow mechanical motion of the wafer or the mask.

The source for generating DUV radiation is generally an excimer laser. The source for EUV radiation may be based on excitation of tin, lithium, or xenon. The use of metallic materials such as tin and lithium presents the difficulty that these materials may be evaporated and become deposited on sensitive optical components. Where xenon is used, light is generated in a xenon plasma either by stimulating it by an electrostatic discharge or by intense laser illumination. Because the EUV radiation has very poor transmissibility through xenon, it is necessary to reduce the pressure in the area around the plasma using a vacuum pumping system. Furthermore, because xenon occurs in atmospheric air in very low concentrations (around 0.087 ppm), the cost is very high. It is therefore very desirable to recover and re-use the xenon.

In a first aspect, the present invention provides extreme ultra violet (EUV) lithography apparatus comprising a lithography tool, such as an optical system, housed in a first chamber, a source of EUV radiation housed in a second chamber connected to the first chamber to enable EUV radiation generated by the source to be supplied to the tool, means for supplying xenon to the source, and pump means in fluid communication with the second chamber for drawing a gaseous flow from the second chamber and conveying the drawn flow to cryogenic purification means for recovering xenon from the flow for subsequent re-supply to the source, wherein at least one of the first and second chambers is in fluid communication with a cryogenic vacuum pump, the apparatus comprising a cryogenic refrigerator for supplying cryogen to the cryogenic purification means and to the or each cryogenic vacuum pump.

A capture pump such as a cryogenic vacuum pump can serve to reduce the base pressure that may be attained in the first and/or second chamber by using a transfer pump, such as a turbomolecular pump, thereby enabling an acceptable vacuum to be created within the chamber. An advantage of employing a cryogenic vacuum pump is that various undesirable gases which may be present in the chamber can be readily removed by the cryogenic vacuum pump. For example, gases with a relatively high boiling point, such as water vapour, can be condensed on to cryogenically cooled pumping surfaces of the pump, whereas gases with relatively lower boiling points, such as helium and hydrogen, can be adsorbed on to the pumping surfaces.

In order to re-use xenon contained in the flow drawn from the second chamber, it is necessary to purify the xenon prior to its return to the source. In the invention, a cryogenic purifier, for example, a cryogenic distillation unit, is used to remove contaminants from the xenon. Examples of such contaminants are water vapour, hydrocarbons, any purge gases introduced into the pump means, any debris generated during the production of EUV radiation within the chamber, and any permanent gases, such as argon, helium or hydrogen, which may enter the second chamber from the first chamber via the connection, such as a passageway, window or other optical link, between the chambers.

Thus, the production of cryogenic temperatures is required for both the cryogenic vacuum pumping of at least one of the chambers and the cryogenic purification of xenon. Providing a single refrigeration apparatus for supplying cryogen, for example, a liquid cryogen such as helium cryogen, to both the cryogenic purifier and the cryogenic vacuum pump(s) can provide for economic cryogenic pumping in the EUV lithography apparatus.

It is preferred that at least the first chamber, which houses the lithography tool, is provided with a cryogenic vacuum pump, as such a pump can assist in the removal of undesirable gases from the vacuum environment to reduce damage to the components of the optical system. It can be advantageous also to provide a cryogenic vacuum pump for the second chamber in order to assist in the removal of undesirable gases which may enter the second chamber from the first chamber. This additional cryogenic vacuum pump can also be supplied with cryogen from the cryogenic refrigerator already provided for both the cryogenic distillation apparatus and the cryogenic vacuum pump for the first chamber, thereby providing for economical cryogenic pumping of the EUV source.

The lithography apparatus may include more than one lithography tool and EUV source. Accordingly, in a second aspect the present invention provides extreme ultra violet (EUV) lithography apparatus comprising a plurality of lithography tools each housed in a respective first chamber, one or more sources of EUV radiation each housed in a respective second chamber, at least one of the chambers being in fluid communication with a cryogenic vacuum pump, means for supplying xenon to the second chamber(s), means for supplying EUV radiation generated from the xenon by the source(s) to the tools, means for conveying a gaseous flow output from the second chamber(s) to cryogenic purification means for recovering xenon from the flow for subsequent re-supply to the source(s), and a cryogenic refrigerator for supplying cryogen to the cryogenic purification means and to the or each cryogenic vacuum pump.

The cryogenic refrigerator may be one of an autocascade refrigerator, a Stirling engine refrigerator, a pulse-tube refrigerator and Joule-Thomson refrigerator.

The invention is also applicable for use with target material other than xenon, such as other inert noble gases, and so in a broader aspect the present invention provides lithography apparatus comprising a lithography tool housed in a first chamber, a source of radiation at or below ultra violet wavelengths housed in a second chamber connected to the first chamber to enable radiation generated by the source to be supplied to the tool, means for supplying target material to the source, and pump means in fluid communication with the second chamber for drawing a gaseous flow from the second chamber and conveying the drawn flow to cryogenic purification means for recovering the target material from the flow for subsequent re-supply to the source, wherein at least one of the first and second chambers is in fluid communication with a cryogenic vacuum pump, the apparatus comprising a cryogenic refrigerator for supplying cryogen to the cryogenic purification means and to the or each cryogenic vacuum pump.

Preferred features of the present invention will now be described, by way of example only, with reference to the accompanying drawing, which illustrates an embodiment of an extreme ultra violet lithography (EUVL) apparatus.

The EUVL apparatus comprises a chamber 10 containing a source 11 of EUV radiation. The source 11 may be a discharge plasma source or a laser-produced plasma source. In a discharge plasma source, a discharge is created in a medium between two electrodes, and a plasma created from the discharge emits EUV radiation. In a laser-produced plasma source, a target is converted to a plasma by an intense laser beam focused on the target. A suitable medium for a discharge plasma source and for a target for a laser-produced plasma source is xenon, as xenon plasma radiates EUV radiation at a wavelength of 13.5 nm. Accordingly, the chamber 10 has an inlet 12 for receiving a flow of xenon and supplying the xenon to the EUV source.

EUV radiation generated in chamber 10 is supplied to another chamber 14 optically linked or connected to chamber 10 via, for example, one or more windows 15 formed in the walls of the chambers 10, 14. The chamber 14 houses a lithography tool 13, for example an optical system which generates a EUV beam for projection on to a mask for the selective illumination of a photoresist on the surface of a substrate, such as a semiconductor wafer. A permanent gas, such as argon, helium or hydrogen, flows within the chamber 14 to prevent photoresist or photo-resist by-products generated during illumination of the substrate from reaching the components of the optical system. Gases may also be present from hydrostatic or hydrodynamic bearings in order to allow mechanical motion of the wafer and/or mask. Xenon may also enter the chamber 14 from chamber 10.

Due to the poor transmissibility of EUV radiation through most gases, a vacuum pumping system is provided for generating a vacuum within chamber 14. In view of the complex variety of gases and contaminants, such as water vapour and hydrocarbons, which may be present in chamber 14, the pumping system for chamber 14 includes both a cryogenic vacuum pump 16 and a transfer pump 18, such as a turbomolecular pump, backed by a roughing pump. Such a combination of pumps can enable a high vacuum to be created in the chamber 14. With reference to the drawing, a cryogen, such as liquid helium, is supplied to the cryogenic vacuum pump 16 by cryogenic refrigerator 20.

As EUV radiation also has a poor transmissibility through xenon, it is also necessary to use a vacuum pumping system to reduce the pressure around the xenon plasma generated by the source in chamber 10. In this embodiment, the pumping system for the chamber 10 includes a transfer vacuum pump 22, such as a turbomolecular pump backed by a roughing pump. The turbomolecular pump 22 draws from the chamber 10 a gaseous flow, including xenon regenerated from the xenon plasma, and contaminants, such as gases entering the chamber 10 from chamber 14 and any debris generated during the production of EUV radiation within the chamber 10. In order to avoid damage to the pump 22, the gas drawn into the pump 22 is mixed with a purge gas from, for example, an inert gas supply connected to an inlet to the pump 22.

The mixed gas exhausted from the pump 22 is received by a cryogenic purifier 24, such as a cryogenic distillation unit, for the recovery of xenon from the gas for re-supply to the chamber 10, thereby enabling the relatively expensive xenon used for the generation of EUV radiation to be repeatedly re-used. The purifier separates the received xenon from the other constituents of the received mixed gas, for example by cryogenically cooling the mixed gas to solidify the xenon contained therein, venting off the other constituents and re-generating gaseous xenon from solidified xenon for return to the inlet 12 of the chamber 10 via line 26.

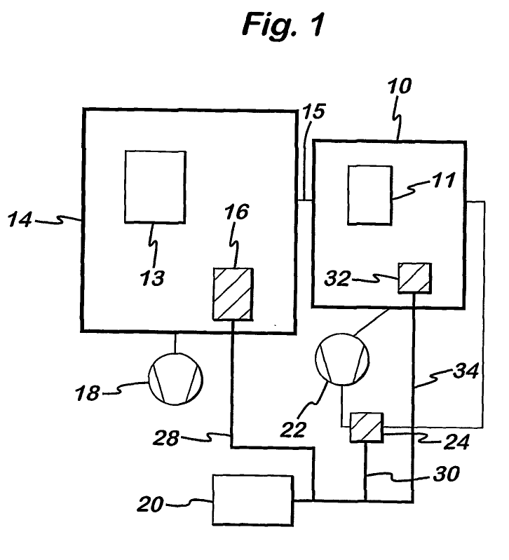

Thus, the EUVL apparatus includes at least two cryogenic components; cryogenic vacuum pump 16 and cryogenic purifier 24. Refrigeration apparatus for supplying a cryogen such as liquid helium to a cryogenic component is generally very inefficient, due both to fundamental thermodynamic limitations (Camot efficiency) and also practical considerations; the cost, power and physical size of apparatus capable of meeting the requirements of a component such as a cryogenic vacuum pump or cryogenic purifier are very high. In view of this, the EUVL apparatus includes only a single cryogenic refrigerator 20 which supplies cryogen to both the cryogenic vacuum pump 16 and cryogenic purifier 24, as opposed to a dedicated refrigeration apparatus for each cryogenic component of the EUVL apparatus. With reference to FIG. 1, refrigerator 20 supplies cryogen to cryogenic vacuum pump 16 via line 28, and supplies cryogen to the cryogenic purifier 24 via line 30.

As also shown in the drawing, a capture vacuum pump 32 is also provided for the is chamber 10 in order to generate in combination with turbomolecular pump 22 the required vacuum level in the chamber 10. Advantageously, the vacuum pump 32 may also be in the form of a cryogenic vacuum pump for removing undesirable gases which may enter the chamber 10 from the chamber 14. This additional cryogenic vacuum pump 32 can conveniently also be supplied via line 34 with cryogen from the cryogenic refrigerator 20 already provided for both the cryogenic purifier 24 and the cryogenic vacuum pump 16 provided for the chamber 14, thereby providing for economical cryogenic pumping of the EUV source without increasing the required number of cryogenic refrigerators.

In summary, lithography apparatus comprises a lithography tool housed in a first chamber, and a source of radiation at or below ultra violet wavelengths housed in a second chamber connected to the first chamber to enable radiation generated by the source to be supplied to the tool. A cryogenic vacuum pump is provided for at least one, preferably for each, of the chambers. A target material, such as xenon, supplied to the source for the generation of radiation is pumped from the second chamber, cryogenically purified and re-supplied to the source. A cryogenic refrigerator supplies cryogen to the cryogenic purifier and to the cryogenic vacuum pump(s).

1. Lithography apparatus comprising a lithography tool housed in a first chamber, a source of radiation at or below ultra violet wavelengths housed in a second chamber connected to the first chamber to enable radiation generated by the source to be supplied to the tool, means for supplying target material to the source, a pump means in fluid communication with the second chamber for drawing a gaseous flow from the second chamber and conveying the drawn gaseous flow to cryogenic purification means for recovering the target material from the flow for subsequent re-supply to the source, wherein at least one of the first and second chambers is in fluid communication with a cryogenic vacuum pump, and a cryogenic refrigerator for supplying cryogen to the cryogenic purification means and to the cryogenic vacuum pump.

2. The apparatus according to claim 1, wherein the at least one of the first and second chambers in fluid communication with cryogenic vacuum pump is the first chamber.

3. The apparatus according to claim 1, wherein the at least one of the first and second chambers in fluid communication with a cryogenic vacuum pump is the second chamber.

4. The apparatus according to claim 1 wherein the pump means comprises a transfer pump.

5. The apparatus according to claim 4, wherein the transfer pump has an inlet for receiving a purge gas for mixing with the drawn flow containing target material and wherein the cryogenic purification means is to receive the purge gas mixed with the drawn flow from the transfer pump and to separate the purge gas from target material contained in the drawn flow.

6. The apparatus according to any claim 1 wherein the cryogenic refrigerator is selected from the group comprising autocascade refrigerator, a Stirling engine refrigerator, a pulse-tube refrigerator and Joule-Thomson refrigerator.

7. The apparatus according to claim 1 wherein the target material is xenon.

8. The Apparatus according to claim 1 wherein the radiation is extreme ultra violet radiation.

9. Extreme ultra violet (EUV) lithography apparatus comprising a lithography tool housed in a first chamber, a source of EUV radiation housed in a second chamber connected to the first chamber to enable EUV radiation generated by the source to be supplied to the tool, means for supplying xenon to the source, pump means in fluid communication with the second chamber for drawing a gaseous flow from the second chamber and conveying the drawn gaseous flow to cryogenic purification means for recovering xenon from the flow for subsequent re-supply to the source, wherein at least one of the first and second chambers is in fluid communication with a cryogenic vacuum pump, and a cryogenic refrigerator for supplying cryogen to the cryogenic purification means and to the cryogenic vacuum pump.

10. Extreme ultra violet (EUV) lithography apparatus comprising a plurality of lithography tools housed in a corresponding one of first chamber, at least one sources of EUV radiation housed in a corresponding one of second chamber, at least one of the chambers being in fluid communication with a cryogenic vacuum pump, means for supplying xenon to at least one of the second chamber(s), means for supplying EUV radiation generated from the xenon by the source(s) to the tools, means for conveying a gaseous flow output from at least one of the second chamber(s) to cryogenic purification means for recovering xenon from the flow for subsequent re-supply to the source(s), and a cryogenic refrigerator for supplying cryogen to the cryogenic purification means and to the or each cryogenic vacuum pump.

11. (canceled)
